(19) United States
(12) Patent Application Publication
(10) Pub. No.: US 2009/0048417 A1
(43) Pub. Date: Feb. 19, 2009

(54) Biodegradable Shower Mat

(76) Inventors: Rebecca Berrigan, Newark, CA (US); Nancy Kathleen Kelley, Newark, CA (US)

Correspondence Address: HEIMLICH LAW, 5952 DIAL WAY, SAN JOSE, CA, 95129, US

(21) Appl. No.: 12/192,802

(22) Filed: Aug. 15, 2008

Related U.S. Application Data
(60) Provisional application No. 60/964,787, filed on Aug. 15, 2007.

(51) Int. Cl. C08G 18/00

(52) U.S. Cl. 528/44

(57) ABSTRACT

A biodegradable shower mat has been disclosed.

### RELATED APPLICATION

This patent application claims priority of U.S. Provisional Application Ser. No. 60/964787 filed 15 Aug. 2007 titled “Personal Disposable Shower Mat”, which is hereby incorporated herein by reference.

### FIELD OF THE INVENTION

The present invention pertains to mats. More particularly, the present invention relates to a biodegradable shower mat.

### BACKGROUND OF THE INVENTION

Shower mats are often used to prevent slippage. Shower mats are often made of a rubber or plastic type material with suction cups and when worn or becoming unusable due to mold, etc. are disposed of in the trash. The rubber or plastic type material is not biodegradable and this may present a problem.

### BRIEF DESCRIPTION OF THE DRAWINGS

The invention is illustrated by way of example and not limitation in the figures of the accompanying drawings in which:

FIG. 1 illustrates one embodiment of the invention showing a top view; and

FIG. 2 illustrates one embodiment of the invention showing a side view.

### DETAILED DESCRIPTION

The invention, as exemplified in various embodiments, illustrates a biodegradable shower mat.

In one embodiment of the invention the shower mat measures approximately 15 in wide×24 in long and 1 in deep. The size of the mat may be proportioned to fit the requirements of use. For example, a larger mat covering essentially the entire surface of a tub (excepting the drain).

In one embodiment of the invention the shower mat is made of a biodegradable substance. Biodegradable substances come in a wide range of degradability. As such, a proper biodegradable substance for a shower mat is compatible with shower water, soap, etc.

In one embodiment of the invention the mat is made of a biodegradable polyurethane blend substance. Biodegradable polyurethane blend substances come in a wide range, and as such, the mat is more foam-like rather than a hard slick surfaced polyurethane.

In one embodiment of the invention the mat has anti-bacterial qualities. Anti-bacterial qualities may be introduced into the mat by combining it with other substances, for example, silver, bamboo, etc.

In one embodiment of the invention the shower mat possess skid-resistant qualities.

In one embodiment of the invention the mat is made of an organic product. Organic products include, but are not limited to, seaweed based products, sponge based products, cellulose based products, etc.

In one embodiment of the invention the mat is aesthetically pleasing to the eye and offered in a variety of colors. A color preference may be based on visibility so as to reduce the likelihood of tripping. Such a preference will be based on the color of the surface on which the mat is placed. For example, a white mat on a white surface is not optimum from the standpoint of visibility. A color, such as tan, may be more preferable.

The disposable shower mat is to be placed in a shower or tub prior to entering the shower or tub, turn the water on and stand or sit on the shower mat during shower or bath.

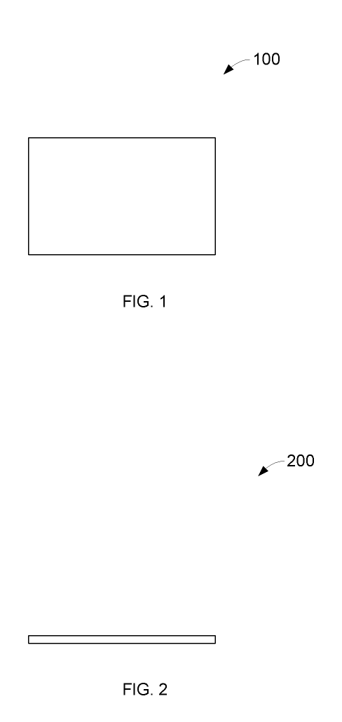

FIG. 1 illustrates, generally at 100, one embodiment of the invention showing a top view.

FIG. 2 illustrates, generally at 200, one embodiment of the invention showing a side view.

Thus a biodegradable shower mat has been described.

What is claimed is:

1. A mat comprising a biodegradable substance.

2. The mat of claim 1 wherein said biodegradable substance is substantially a rectangular shape.

3. The mat of claim 2 wherein said biodegradable substance is an organic product.

4. The mat of claim 2 wherein said biodegradable substance is a polyurethane blend.

5. The mat of claim 1 wherein said biodegradable substance possesses anti-bacterial qualities.

6. The mat of claim 1 wherein said biodegradable substance possesses skid resistant qualities.

7. A mat comprising a rectangular shaped organic biodegradable substance having skid resistant qualities:
